(19) United States
(12) Patent Application Publication
(10) Pub. No.: US 2011/0154404 A1
(43) Pub. Date: Jun. 23, 2011

(54) Systems and Methods to Provide Data Services for Concurrent Display with Media Content Items

(75) Inventors: David Piepenbrink, Chicago, IL (US); Lee M. Chow, Naperville, IL (US); Stephen Rys, Austin, TX (US); James T. Sofos, Aurora, IL (US)

(73) Assignee: AT & T INTELLECTUAL PROPERTY I, L.P., Reno, NV (US)

(21) Appl. No.: 12/640,260

(22) Filed: Dec. 17, 2009

(51) Int. Cl. H04N 5/445; H04N 7/16

(52) U.S. Cl. 725/53; 725/62

(57) ABSTRACT

Systems and methods to provide data services for concurrent display with media content items are provided. The media content items may include an on-demand media content item or an over-the-air (OTA) television content item. A particular method includes receiving a program identifier associated with an OTA television content item from a set-top box device. The method includes identifying one or more supplemental content items associated with the OTA television content item based on the program identifier. The method also includes transmitting a notification to the set-top box device indicating an availability of the one or more supplemental content items.

### FIELD OF THE DISCLOSURE

The present disclosure is generally related to providing data services for concurrent display with media content items (e.g., on-demand media content items and over-the-air (OTA) television content items).

### BACKGROUND

Media content items such as television programs and movies may be received by a user as over-the-air (OTA) television content items from broadcast transmitters or as on-demand media content items from service providers (e.g., internet service providers, cable network providers, satellite network providers, or internet protocol television network providers). When the user wishes to obtain supplemental data related to a particular media content item that the user is viewing on a display device, the user may have to use a separate device, such as a personal computer or some other web enabled device, to access the supplemental data. The need to use a separate device to access supplemental data may result in a disjointed experience for the user.

### BRIEF DESCRIPTION OF THE DRAWINGS

FIG. 1 is a block diagram of a particular embodiment of a system to provide data services for concurrent display with media content items.

FIG. 2 is a representation of a particular embodiment of an electronic program guide (EPG) displayed on a display device.

FIG. 3 is a representation of a particular embodiment of a portion of data in a database that may be accessed to provide data services for concurrent display with media content items.

FIG. 4 is a representation of an embodiment of a display device that includes a display of a particular media content item and a display of selected data related to an OTA television content item.

FIG. 5 is a flow diagram of a first embodiment of a method to provide data services for concurrent display with media content items.

FIG. 6 is a flow diagram of a second embodiment of a method to provide data services for over-the-air (OTA) television content items.

FIG. 7 is a block diagram of an illustrative embodiment of a general computer system.

### DETAILED DESCRIPTION

A service provider may use existing infrastructure to deliver over-the-air (OTA) television content items and on-demand media content items to customers. For example, the service provider may use an existing public internet backbone to deliver on-demand media content items to customer premises equipment (e.g., set-top box devices). Each set-top box device may receive local channels as over-the-air (OTA) broadcasts through an antenna coupled to the set-top box device. An authenticated and authorized set-top box device may solicit on-demand media content from a service provider network. The set-top box device may request from the service provider network a listing of supplemental content related to a particular media content item (e.g., a particular OTA television content item) that a user is viewing on a display device. The set-top box device may provide the user with an option to concurrently display the particular media content item and supplemental content related to the particular media content item. When the user chooses to concurrently display the supplemental content with the particular media content item, the set-top box device may retrieve selected supplemental content via a public network for concurrent display on the display device with the particular media content item.

In a particular embodiment, a method includes receiving a program identifier associated with an OTA television content item from a set-top box device. The method includes identifying one or more supplemental content items associated with the OTA television content item based on the program identifier. The method also includes transmitting a notification to the set-top box device indicating an availability of the one or more supplemental content items.

In a particular embodiment, a computer-readable storage medium includes instructions, that when executed by a processor, cause the processor to receive a program identifier associated with an OTA television content item. The computer-readable storage medium includes instructions, that when executed by the processor, cause the processor to send the program identifier to a server. The computer-readable storage medium includes instructions, that when executed by the processor, cause the processor to receive a notification of available supplemental content associated with the OTA television content item from the server. The computer-readable storage medium also includes instructions, that when executed by the processor, cause the processor to display an option to concurrently view the supplemental content concurrently with the OTA television content item at a display device.

In a particular embodiment, a system includes a network interface that is configured to receive a program identifier from a device. The program identifier is associated with an over-the-air (OTA) television content item. The network interface is also configured to transmit a notification to the device indicating an availability of one or more supplemental content items associated with the OTA television content item. The system also includes supplemental content identification logic configured to identify the one or more supplemental content items based on the program identifier.

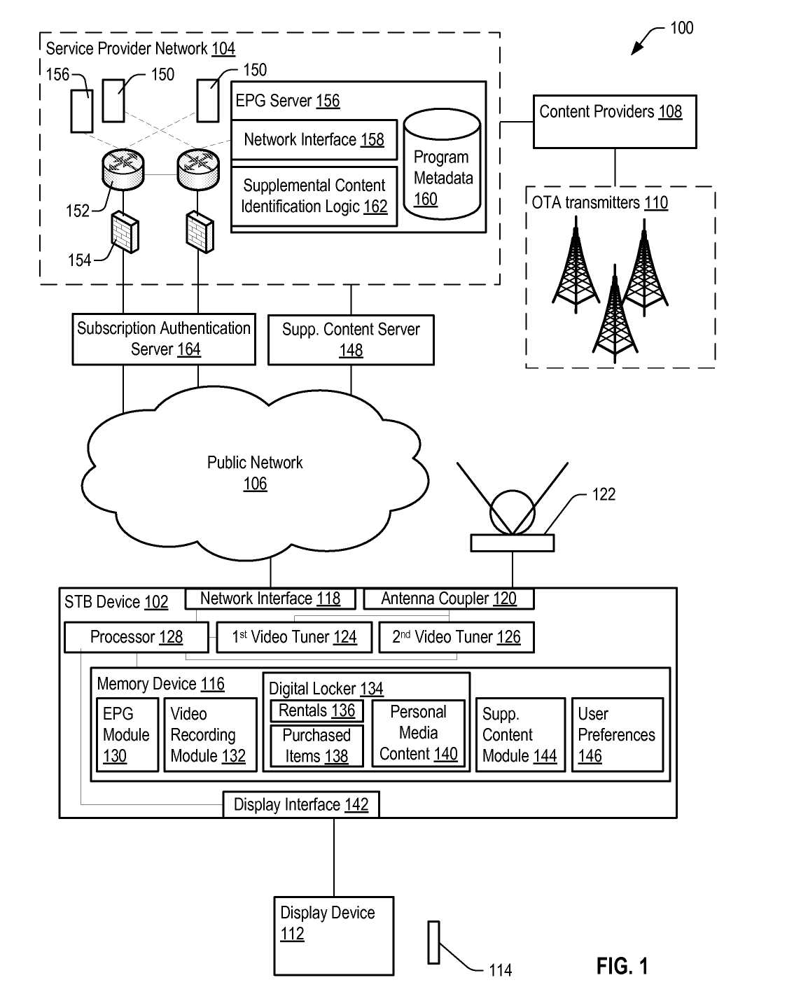

Referring to FIG. 1, a block diagram of a particular embodiment of a system to provide data services for concurrent display with media content items is designated generally 100. The system 100 may include a set-top box device 102 in communication with a service provider network 104 via a public network 106. The service provider network 104 may be a portion of a system that provides access to the public network 106 for customers. The service provider network 104 may be part of a system maintained by a service provider such as an internet service provider, a cable television system provider, an internet protocol television system provider, a satellite television system provider, other service provider, or combinations thereof. The service provider may also have one or more additional service provider networks 104 to accommodate service to customers in various regions, to accommodate customers in regions with off-line equipment, or both. The service provider network 104 may provide television content and other media content provided by one or more content providers 108 to customers. The public network 106 may be an internet protocol (IP) based network, such as the Internet.

The set-top box device 102 may also receive broadcasts from one or more over-the-air (OTA) transmitters 110. The OTA transmitters 110 may include television content broadcast transmitters associated with local programming content available from one or more of the content providers 108.

The set-top box device 102 may be able to receive media content from the service provider network 104 and from the OTA transmitters 110. The set-top box device 102 may process the media content for display via a display device 112. The media content may also be sent from the set-top box device 102 to other devices via the public network 106 or via a local area network (LAN). The other devices may be, but are not limited to, computer systems, personal media players, and communication devices having internet capabilities. The set-top box device 102 may receive user input from a remote control device 114 and from the other devices.

The set-top box device 102 may also be able to receive media content from other sources including media content from one or more third party content providers via the public network 106, media content and personal media content from one or more other devices via the public network 106 or via a LAN, and stored media content from a memory device 116 of the set-top box device 102. Examples of third party content providers may include, but are not limited to, YouTube®, news feeds such as CNN Newsource®, and the iTunes Store®. The media content from the service provider network 104, from the OTA transmitters 110, and from the other sources may include, but is not limited to, television content, on-demand media content (e.g., video-on-demand, movies, music, and games), applications and services available via the public network 106 (e.g., YellowPages.com®, weather web sites, and game web sites), and personal media content (e.g., user generated video, photographs, slide shows, music, and other multimedia content). The on-demand media content may be available in a standard definition (SD) format, a high definition (HD) format, or both.

The set-top box device 102 may include a network interface 118 to receive media content via the public network 106 and a LAN. The set-top box device 102 may also include an antenna coupler 120 to couple to one or more antennas 122. The one or more antennas 122 may receive television broadcast transmissions from the OTA transmitters 110. The one or more antennas 122 may be an integral component of the set-top box device 102, may be an indoor antenna coupled by a coaxial cable or other connector to the set-top box device 102, may be an outdoor antenna coupled by a coaxial cable or other connector to the set-top box device 102, or may be combinations thereof.

The antenna coupler 120 may be in communication with one or more video tuners, such as a first video tuner 124 and a second video tuner 126. The one or more video tuners 124, 126 may include one or more Advanced Television Systems Committee (ATSC) tuners. In a particular embodiment, the first video tuner 124 may receive digitally broadcast transmissions and the second video tuner 126 may receive analog broadcast transmissions. The video tuners 124, 126 may allow for the reception of SD video content, HD video content, analog video content, digital video content, or any combination thereof, broadcast from the OTA transmitters 110 and in range of the one or more antennas 122 coupled to the antenna coupler 120 of the set-top box device 102.

The set-top box device 102 may also include a processor 128 configured to process media content received via the network interface 118 or from one of the video tuners 124, 126. For example, the processor 128 may process the media content for display at the display device 112. The processor 128 may process requests, data, media content, or other information that is to be sent to the service provider network 104 or another network device coupled to the set-top box device 102 via the public network 106.

The memory device 116 may include an EPG module 130 to generate an EPG for display at the display device 112. In a particular embodiment, the EPG module 130 generates the EPG to concurrently display data descriptive of on-demand media content items that are available from the service provider network 104 via the public network 106 and data descriptive of OTA television content items available from the OTA transmitters 110 via the one or more television broadcast transmissions.

The memory device 116 may include a video recording module 132. The video recording module 132 may digitally record user selected on-demand media content items and user selected OTA television content items to a digital locker 134 of the memory device 116. The video recording module 132 may allow user selected on-demand media content items and user selected OTA television content items to be recorded to a network digital video recorder coupled to, or otherwise accessible to, the set-top box device 102. The network digital video recorder may be coupled by wire or wirelessly to the set-top box device 102 or may be part of a service available from the service provider and accessed through the public network 106. The digital locker 134 may include rented media content 136, purchased media content 138, and personal media content 140. Particular rented media content items of the rented media content 136 may automatically be deleted after a certain time or after the particular rented media content items have been viewed. The personal media content 140 may include, but is not limited to, home videos, music, games, and photographs.

The processor 128 may allow the video recording module 132 to record an OTA television content item in the digital locker 134 of the memory device 116. The processor 128 may allow the video recording module 132 to record an on-demand media content item in the digital locker 134 of the memory device 116. The processor 128 may allow the video recording module 132 to simultaneously record a first OTA television content item and a first on-demand media content item in the digital locker 134 of the memory device 116. The processor 128 may allow an additional media content item to be sent to the display device 112 via a display interface 142.

The memory device 116 may also include a supplemental content module 144. When a user of the set-top box device 102 selects particular media content item to view on the display device 112 (e.g., a particular on-demand media content item or a particular OTA television content item), the supplemental content module 144 may send a request to the service provider network 104 for supplemental content that may be displayed concurrently with the particular media content on the display device 112. The request for supplemental content may be sent after a delay time has elapsed from when the user chooses the particular media content item to accommodate channel surfing or a channel change for another reason. The delay time may be chosen by the user and stored in user preferences 146 in the memory device 116. A As an example, a default value for the delay time may be a one minute. In some embodiments, a setting in the user preferences 146 may only allow activation of the supplemental content module 144 upon user request via the remote control device 114.

The request for supplemental content may include a program identifier of the particular media content item. The program identifier may be a unique identifier of the program that is extracted from the particular media content item. The program identifier may be included in metadata of the particular media content item when the particular media content item is a digital content item. The program identifier may be included in vertical blanking intervals of the particular media content item when the particular media content item is an analog content item. The program identifier may be included in the particular media content item using other methods. The particular media content item may be a live presentation that is streaming from the service provider network 104 or broadcast by the OTA transmitters 110. Alternately, the particular media content item may be a time-shifted presentation of the particular media content (i.e., the particular media content item is a playback of a previously recorded media content item). The supplemental content module 144 may send to the service provider network 104 a program identifier of the particular media content item and applicable preferences from the user preferences 146 stored in the memory device 116. The program identifier may be extracted from the particular media content item. The user preferences 146 may include user supplied preferences that provide limitations or guides for information and content that the set-top box device 102 retrieves and presents to the user via the display device 112. For example, the user preferences 146 may include a limit to the number of results returned in response to a request for information.

In response to the request for supplemental content, the service provider network 104 may return to the set-top box device 102 a list of available supplemental content. The list of available supplemental content may include identifiers of web sites, media content, data, other information, or combinations thereof associated with the particular media content. The list of available supplemental content may be provided by the content providers 108, may include results of one or more searches of a catalog of a supplemental content server 148, may include results presented by a search engine available via the public network 106, or may be combinations thereof. The searches may be based on the unique program identifier, may be based on metadata for the program available to the service provider network 104, or may be based on both the unique program identifier and the metadata.

The supplemental content module 144 may generate a first graphical user interface (GUI) that is sent to the display device 112. The first GUI may provide an option to concurrently view the particular media content item and at least one supplemental content item from the list of available supplemental content. When the user does not select to concurrently view the particular media content item and at least one supplemental content item from the list of available supplemental content, the processor 128 may send the particular media content item through the display interface 142 to the display device 112. When the user selects the option to concurrently view the particular media content item and at least one supplemental content item from the list of available supplemental content, the supplemental content module 144 may generate a second GUI that is sent to the display device 112. The second GUI may allow the user to choose at least one supplemental content item to be viewed concurrently with the particular media content item.

The supplemental content module 144 may send identifiers of the at least one selected supplemental content item to the service provider network 104. The service provider network 104 may retrieve the at least one selected supplemental content item from the supplemental content server 148 or other source for the at least one selected supplemental content item. The service provider network 104 may send the at least one selected supplemental content item to the set-top box device 102 so that the set-top box device 102 can concurrently provide the at least one selected supplemental content item and the particular media content item to the display device 112.

The content providers 108 may provide subscription based content to one or more intake servers 150 of the service provider network 104. The subscription based content may include content provided by the service provider to customers on a subscription basis. Examples include television content traditionally associated with basic cable service. The content providers 108 may also provide premium media content via the one or more intake servers 150 of the service provider network 104. Examples of premium content may include premium channels traditionally available via cable television service providers on a premium content basis (e.g., HBO® and SHOWTIME®). The content providers 108 may also provide content provided by broadcast networks when the local affiliate of the broadcast network is not accessible to the set-top box device 102 through a broadcast from the OTA transmitters 110.

The service provider network 104 may include one or more routers 152 to route content received from the content providers 108 to one or more customers associated with the service provider. The service provider network 104 may also include one or more firewalls 154 to restrict access to the service provider network 104, to the one or more intake servers 150, and to one or more other servers associated with the service provider.

The service provider network 104 may include one or more EPG servers 156. The EPG servers 156 may provide data that describes the media content items provided by the service provider network 104 through the public network 106, including start times and end times for the media content items. The media content items may include subscription based content and on-demand media content.

Each EPG server 156 may include a network interface 158, program metadata 160, and a supplemental content identification logic 162. The network interface 158 may allow the EPG server 156 to communicate with other devices (e.g., the set-top box device 102) via the public network 106. The program metadata 160 may include information related to programs provided by the content providers 108. The program metadata 160 may include, but is not limited to, program identifiers, titles of programs, episode titles, start times for the programs, lengths of the programs, short descriptions of program content, listings of stars in the programs, names of directors of the programs, and identifiers of supplemental content provided by the content providers 108. The supplemental content may retrieve from a database that is indexed by the program identifiers. The supplemental content identification logic 162 may include processor executable instructions that allows the EPG server 156 to search the program metadata 160 for program identifiers and particular metadata.

The EPG module 130 of the set-top box device 102 may modify data received from the EPG servers 156 to include data that describes the OTA television content items so that the EPG produced by the EPG module 130 concurrently displays the on-demand media content items available from the service provider network 104 and the OTA television content items available from the OTA transmitters 110. The data that describes the OTA television content items may be obtained via the public network 106 from web pages of the broadcast stations providing the broadcast transmissions, from news services that provide local television content, from other sources, or combinations thereof. The data may include a start time and an end time for the OTA television content items.

The EPG module 130 may also include other options for retrieving additional media content identified by the EPG produced by the EPG module 130. The other options may include, but are not limited to, providing access to a catalog of on-demand media content available from the service provider, providing access to content of the set-top box device 102 stored in the digital locker 134, providing access to a catalog of on-demand media content available from one or more third party content providers, and providing access to media content available from one or more devices coupled to the set-top box device 102 by the LAN or by the public network 106. The EPG module 130 may provide the generated EPG to the display device 112 when the set-top box device 102 receives a request for the EPG to be sent to the display device 112.

A subscription authentication server 164 may be associated with the service provider. The subscription authentication server 164 may authenticate a particular set-top box device, such as the set-top box device 102, to verify that the particular set-top box device is authorized to access particular media content provided by the service provider network 104.

In a particular embodiment, the set-top box device 102 may receive user input related to a particular media content item presented in the EPG provided by the EPG module 130, selected using channel up or channel down keys of the remote control device 114, or selected using numeric inputs of the remote control device 114. When the particular media content item is a subscription based content item from the service provider network 104, the set-top box device 102 may send an authentication message to the subscription authentication server 164 to authenticate that the set-top box device 102 is authorized to access the particular media content item. Access may be denied when the user does not have authorization to the particular media content item. When the user does have authorization to the particular media content item, the system 100 may allow retrieval of the particular media content item.

When the particular media content item is an OTA television content item available via the OTA transmitters 110, the set-top box device 102 may determine whether a broadcast time for the particular content item has been reached. When the broadcast time for the content item has been reached, or been substantially reached (e.g., within two minutes of a start time for the particular media content item) one of the video tuners 124, 126 may be tuned to a channel associated with the particular media content item.

When the broadcast time associated with the particular media content item has not been substantially reached, the set-top box device 102 may implement a search to determine whether the selected content item is available as an on-demand content item via a third party content provider or via the service provider network 104. When the particular media content item is available as an on-demand content item, the set-top box device 102 may send a notification message to the user that the particular media content item is available as on-demand media content. The notification message may provide an option to retrieve the on-demand media content item via the public network 106. When a user selects to receive the particular media content item as the on-demand media content item via the public network 106, the set-top box device 102 may send a request to retrieve the particular media content item.

In a particular embodiment, the user may use the EPG provided by the EPG module 130 to schedule a particular media content item for recording via the video recording module 132. The set-top box device 102 may check to see if the media content corresponding to the particular media content item is available immediately as on-demand media content. When the particular media content item is available immediately as on-demand media content, the set-top box device 102 may notify the user of the availability and provide an option to store the on-demand media content in the memory device 116 of the set-top box device 102, immediately show the particular media content item, or both. When the particular media content item is not available immediately as on-demand media content, or when the user opts not to retrieve the immediately available on-demand media content, the processor 128 of the set-top box device 102 may execute instructions of the video recording module 132 to schedule a recording event to record the particular media content item to the memory device 116. The recording event may include a recording start time and a recording stop time. When the particular media content item is an OTA television content item, the set-top box device 102 may tune one or more of the video tuners 124, 126 to a broadcast channel associated with the OTA television content item at the start time and store the OTA television content item in the memory device 116.

The user may use the remote control device 114 to begin recording a channel that is currently displayed on the display device 112. When the user elects to record a channel currently displayed on the display device 112, the video recording module 132 may begin recording the media content currently displayed on the display device 112 and may display a timing GUI that prompts the user to select a time to end recording of the channel. After the time to end recording of the channel is selected, the user may change the channel without interrupting or changing what is being recorded.

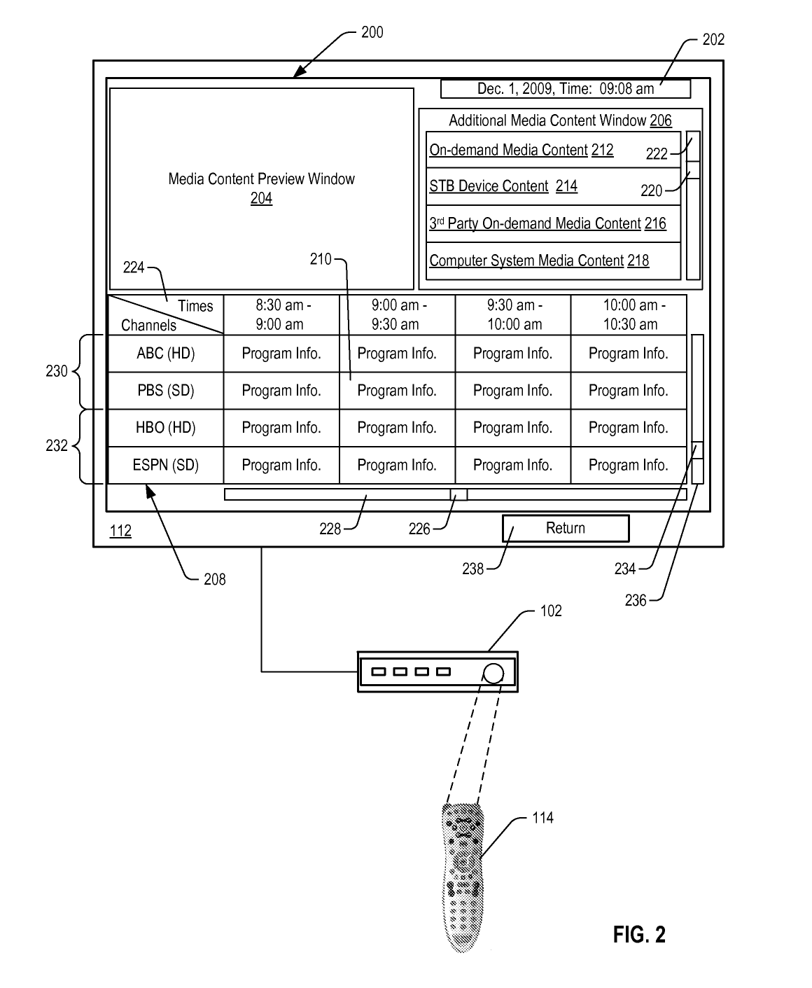

Referring to FIG. 2, a representation of a particular embodiment of an EPG displayed on the display device 112 is designated generally as 200. The display device 112 may be coupled to the set-top box device 102. The set-top box device 102 in FIG. 2 may be similar to or the same as the set-top box 102 shown in FIG. 1. A user may send input to the set-top box device 102 using the remote control device 114. The EPG 200 may include a date and time window 202, a media content preview window 204, an additional media content window 206, and an EPG table 208. The data and time window 202 may display the current date and time.

The media content preview window 204 may display content that is currently presented on a channel corresponding to an entry 210 of the EPG table 208 that is highlighted when a time range for the entry 210 includes the current time. When the time range corresponding to the entry 210 that is highlighted does not include the current time, the set-top box device 102 may retrieve information from one or more sources (e.g., a service provider network, a broadcast source, or other information source related to the media content) to be displayed in the media content preview window 204. When no information for the media content corresponding to the entry 210 is available from the one or more sources, a channel logo for a channel that corresponds to the entry 210 or other content may be displayed in the media content preview window 204. When information related to the media content corresponding to the entry 210 is retrieved from the one or more sources, the information may be displayed in the media content preview window 204. The information may include, but is not limited to, a preview clip of the media content, a still image corresponding to the media content, information regarding the media content to be shown during the time entry range, or combinations thereof.

Each entry 210 of the EPG table 208 may display information related to a program that is to be shown on the channel corresponding to the row during the time period corresponding to the column. The information may include the name of the program. Additional information for a particular entry may be presented when the particular entry is highlighted or otherwise selected. The additional information may include, but is not limited to, an episode title when the program is a serial program, special guest stars in the program when the program is a serial program, actors in the program, director of the program, information related to the content of the program, and combinations thereof.

The additional media content window 206 may include one or more selectable entries 212-218. Selection of a particular selectable entry of the selectable entries 212-218 by the user using the remote control device 114 may cause the set-top box device 102 to send a graphical user interface (GUI) to the display device 112. The GUI may show media content that is available from the particular selectable entry. For example, selection of the On-demand Media Content selectable entry 212 may cause the set-top box device 102 to present a GUI that allows the user to search and select media content available via a public network from a catalog of content available from a service provider that provides access to the public network for the user. Selection of the STB Device Content selectable entry 214 may cause the set-top box 102 to present a GUI that allows the user to select media content for display from a digital locker of the set-top box device 102. The media content may be rented media content, purchased media content, or personal media content (e.g., personal videos and photograph slideshows). Selection of the Third Party On-demand Media Content selectable entry 216 may cause the set-top box device 102 to present a GUI that allows the user to search and select media content for rent or purchase from a catalog of a third party on-demand media content service. Selection of the Computer System Media Content selectable entry 218 may cause the set-top box device 102 to present a GUI that displays media content available from a computer system coupled to the set-top box device 102 by a LAN or other network connection. When the computer system is not coupled to the set-top box device 102, the Computer System Media Content selectable entry 218 may not appear or may not be selectable. The titles for the selectable entries 212-218 are representative and other titles may be chosen. When the additional media content window 206 includes additional selectable entries, the additional selectable entries may be accessed using a down key and an up key of the remote control device 114. A position in a listing of all the selectable entries 212-218 in the additional media content window 206 may be indicated by an indicator 220 of a scroll bar 222.

The EPG table 208 may present media content items available as OTA television content items and on-demand media content items provided from the service provider network in a single location. A first entry 224 in the EPG table 208 may indicate that a first row of the EPG table 208 displays time ranges and a first column of the EPG table 208 displays channels. Times indicated in the time ranges in the first row may correspond to times when display of media content typically starts or ends. Additional time ranges may be viewed by navigating to the right or left in the EPG table 208 using right and left keys of the remote control device 114. The entry 210 that is currently selected may be highlighted or indicated by some other visual distinction from other entries 210. A general position of a selected entry relative to the possible time range entries in the EPG table 208 may be indicated by an indicator 226 in a scroll bar 228. When the user has selected an entry 210 in the EPG table 208 corresponding to a time range that does not include the current time, the user may switch to the entry 210 in the same row with a time range that includes the current time by using the right and the left keys of the remote control device 114 or by pressing the home key of the remote control device 114.

The channels presented in the first column of the EPG table 208 may include OTA channels 230 that one or more tuners of the set-top box device 102 are able to identify and tune. Names of the channels 230 may correspond to names of networks that provide the OTA content for the channels 230. The OTA channels 230 may include standard definition (SD) channels and high definition (HD) channels. Two OTA channels 230 are depicted in FIG. 2, but fewer or more OTA channels 230 may be available to the set-top box device 102. The channels presented in the first column of the EPG table 208 may include channels 232 from the service provider network via the public network. Names of the channels 232 may correspond to names of networks that provide content for the channels 232. The channels may include indications that inform the user whether the content of the channels 232 is presented in a standard definition (SD) format or a high definition (HD) format. Two channels 232 from the service provider network via the public network are depicted in FIG. 2, but fewer or more channels 232 from the service provider network via the public network may be available to the set-top box device 102. Additional OTA channels 230 and additional channels 232 from the service provider network via the public network available to the set-top box device 102 may be viewed by navigating up and down in the EPG table 208 using the remote control device 114. A general position of a selected entry relative to the possible channels in the EPG table 208 may be indicated by an indicator 234 in a scroll bar 236.

The user may request the EPG 200 by pressing an EPG key on the remote control device 114. The EPG 200 presented by the set-top box device 102 may highlight the entry 210 in the EPG table 208 that corresponds to the current time and the present selected channel. The media content preview window 204 may display the media content that was displayed on the display device 112 prior to receipt of the request for the EPG 200. The user may navigate to another entry 210 or to another window of the EPG 200 using the keys of the remote control device 114. When the user moves to a different entry in the EPG table 208, the different entry is highlighted and the display presented in the media content preview window 204 may change. The user may choose to view the media content corresponding to the different entry by pressing a play key of the remote control device 114. The user may choose to schedule the different entry for recording by pressing a record key of the remote control device 114. The user may exit the EPG 200 by navigating to a return button 238 of the EPG 200 or by pressing a return key of the remote control device 114.

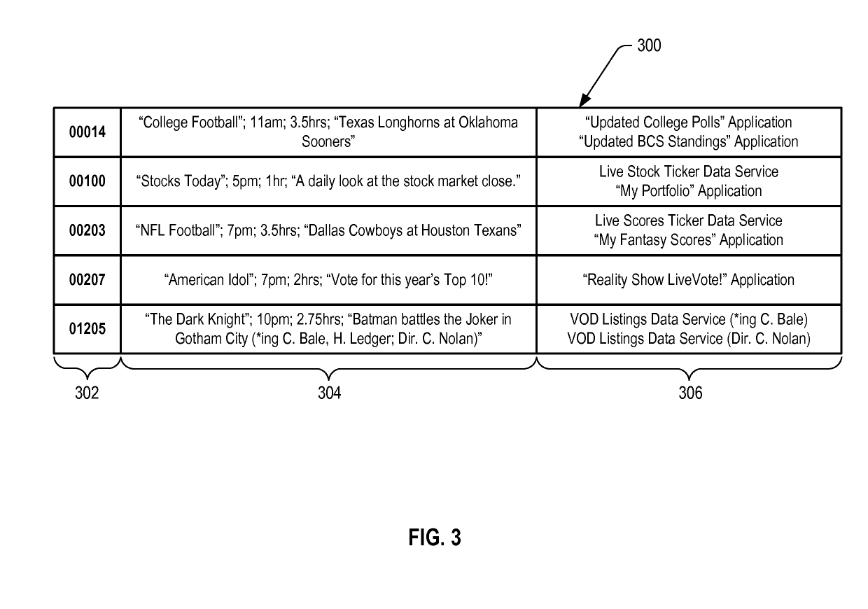

Referring to FIG. 3, a representation of a particular embodiment of a portion of data in a database (e.g., a portion of data from the program metadata 160 of the EPG server 156 depicted in FIG. 1) that may be accessed to provide data services for concurrent display with media content items is illustrated. The data is represented as a table 300. The table 300 may include a first column 302 that includes program identifiers. The program identifiers are unique identifiers of particular media content items.

The table 300 may include a second column 304 that includes metadata. The metadata in a particular row in the second column 304 corresponds to metadata for the media content item corresponding to the program identifier in the first column 302 of the same row. The metadata in an entry of the second column 304 may include, but is not limited to, a title of the program, an episode title, a date, a start time for the program, a length of the program, a short description of the program, a listing of stars in the program, and a name of the director of the program.

The table may include a third column 306 that includes available supplemental content. The available supplemental content in a particular row in the third column 306 corresponds to available supplemental content for the media content item corresponding to the program identifier in the first column 302 of the same row. The available supplemental content in the third column 306 may be provided by content providers (e.g., the content providers 108 depicted in FIG. 1) and may be available from a supplemental content server (e.g., the supplemental content server 148 depicted in FIG. 1).

A service provider network (e.g., the service provider network 104 depicted in FIG. 1) may receive a request for supplemental content related to a particular media content item identified by a particular program identifier from a set-top box device (e.g., the set-top box device 102 depicted in FIG. 1). The service provider network may also receive one or more user preferences with the request. The service provider network may search the database, as represented by the table 300, for the particular program identifier. When the service provider network finds the particular program identifier in the first column 302 of the table 300, the service provider network may search a catalog of the supplemental content server for supplemental content that is related to the particular media content item identified by the particular program identifier based on the program identifier, one or more entries from the metadata in the entry of the second column 304 corresponding to the program identifier, the user preferences, or combinations thereof. The results may include a first listing of supplemental content. The service provider network may also use one or more search engines available via a public network (e.g., public network 106 depicted in FIG. 1) to obtain listings of additional supplemental content related to the particular media content item identified by the particular program identifier based on the program identifier, one or more entries from the metadata in the entry of the second column 304 corresponding to the program identifier, the user preferences, or combinations thereof. The results may include a second listing of supplemental content.

The service provider network may create a third listing of supplemental content that combines the first listing of supplemental content, the second listing of supplemental content, and one or more entries from the supplemental content in the entry of the third column 306 corresponding to the program identifier. The third listing may be limited by one or more of the user preferences. The third listing may be returned to the set-top box device.

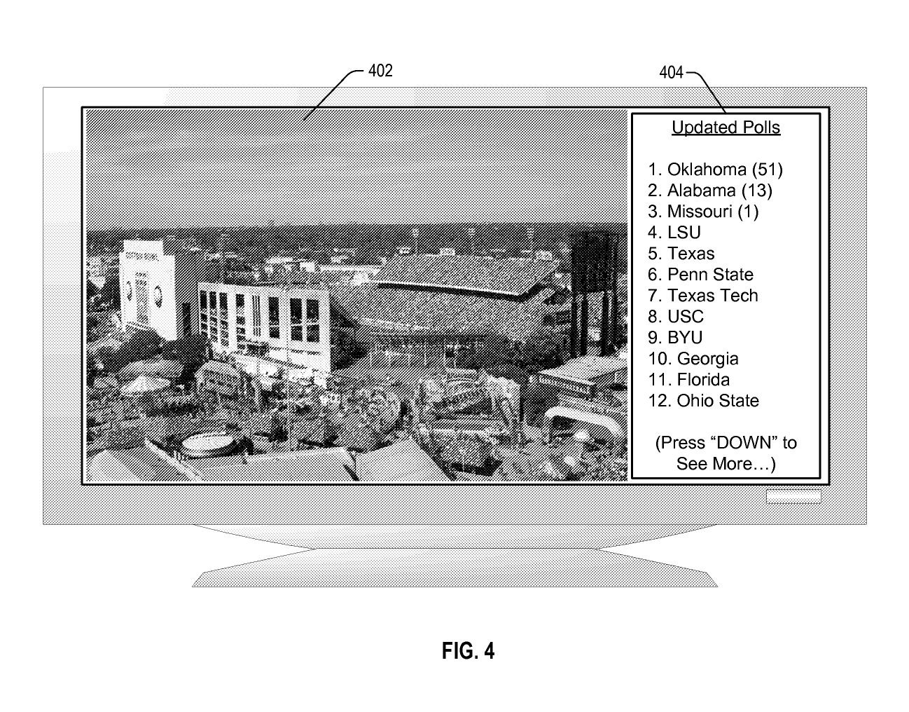

Referring to FIG. 4, a representation of an embodiment of a display device 112 showing a particular media content item 402 and a selected data service GUI 404 for the particular media content item 402 is illustrated. The particular media content item 402 may be a live or time-delayed on-demand media content item or a live or time-delayed OTA television content item. The particular media content item 402 may be sent from a set-top box device (e.g., the set-top box device 102 depicted in FIG. 1) to the display device 112. The display device 112 also shows the selected data service GUI 404 for the particular media content item 402. The selected data service GUI 404 may be generated at the set-top box device, at a network server, or portions of the selected data service GUI 404 may be generated at the set-top box device and the network server.

In some embodiments, the selected data service GUI 404 may overlay a portion of the particular media content item 402. In some embodiments, the particular media content item 402 may be sized so that the selected data service GUI 404 does not overlay the particular media content item 402.

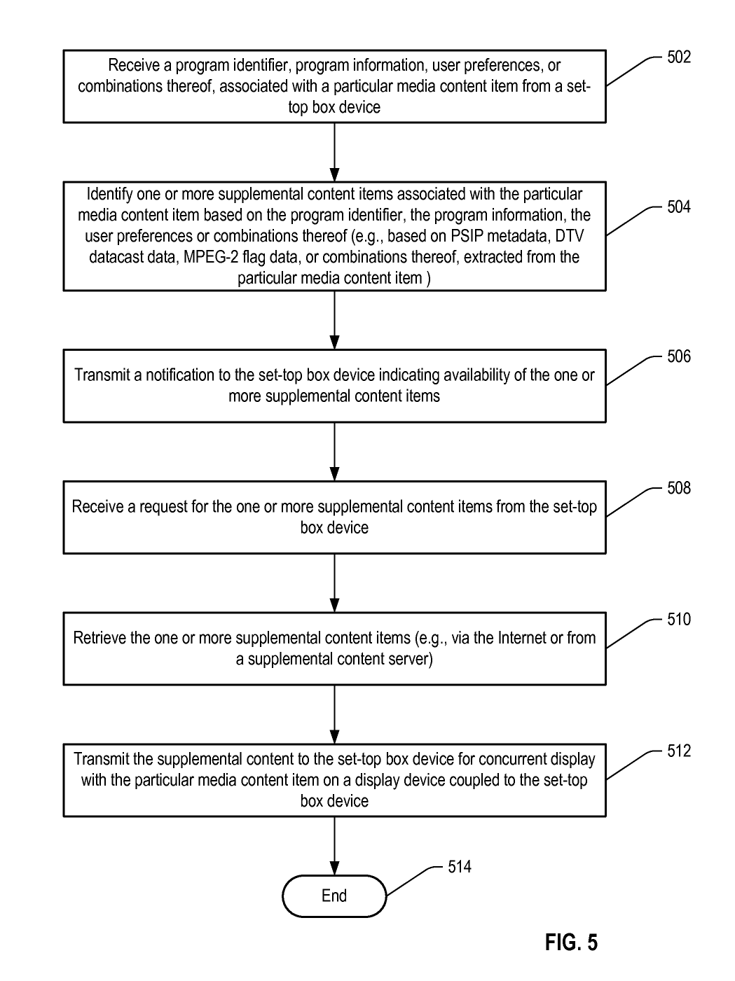

Referring to FIG. 5, a first embodiment of a method to provide data services for concurrent display with media content items is illustrated. The particular media content item may be an on-demand media content item or an OTA television content item. The particular media content item may be a live presentation or a time-delayed presentation. A live presentation occurs when the particular media content item is being retrieved from a service provider network (e.g., service provider network 104 depicted in FIG. 1) or a broadcast transmitter (e.g., a broadcast transmitter of the broadcast transmitters 110 depicted in FIG. 1) and displayed on a display device (e.g., the display device 112 depicted in FIG. 1). A time-delayed presentation occurs when the particular media content item is displayed on the display device as a playback of a recording of the particular media content item stored at a set-top box device (e.g., the set-top box device 102) or a recording device (e.g., a digital video recorder) coupled to the set-top box device. The method includes, at 502, receiving a program identifier, program information, or both, associated with the particular media content item from the set-top box device. The program identifier and the program information may be retrieved from Program and System Information Protocol (P SIP) metadata, digital television (DTV) datacast data, motion picture experts group 2 (MPEG-2) flag data, or combinations thereof, which are extracted from the particular media content item.

At 504, one or more supplemental content items associated with the particular media content item based on the program identifier, the program information, the user preferences, or combinations thereof, may be identified. The one or more supplemental content items may be identified based on program metadata retrieved from a metadata server (e.g., the EPG server 156 depicted in FIG. 1) based on the program identifier, the program information, or both. Identifying the one or more supplemental content items based on the program metadata may include performing an Internet keyword search of the program metadata, a database query based on the program metadata, or both. Identifying the one or more supplemental content items based on the program metadata may include performing a keyword search of the program metadata at a supplemental content server (e.g., the supplemental content server 148 depicted in FIG. 1). The metadata may include, but is not limited to, information associated with a genre, a subject, an athlete, a team, a cast member, a crew member of the OTA television content item, or combinations thereof.

At 506, a notification may be transmitted to the set-top box device indicating availability of the one or more supplemental content items. At 508, a request for the one or more supplemental content items may be received from the set-top box device.

The one or more supplemental content items may be retrieved, at 510. The one or more supplemental content items may be retrieved from a web site via the Internet, via the supplemental content server, or both. The retrieved supplemental content may be transmitted to the set-top box device for concurrent display with the particular media content item on a display device (e.g., display device 112 depicted in FIG. 1) coupled to the set-top box device, at 512. The method ends, at 514.

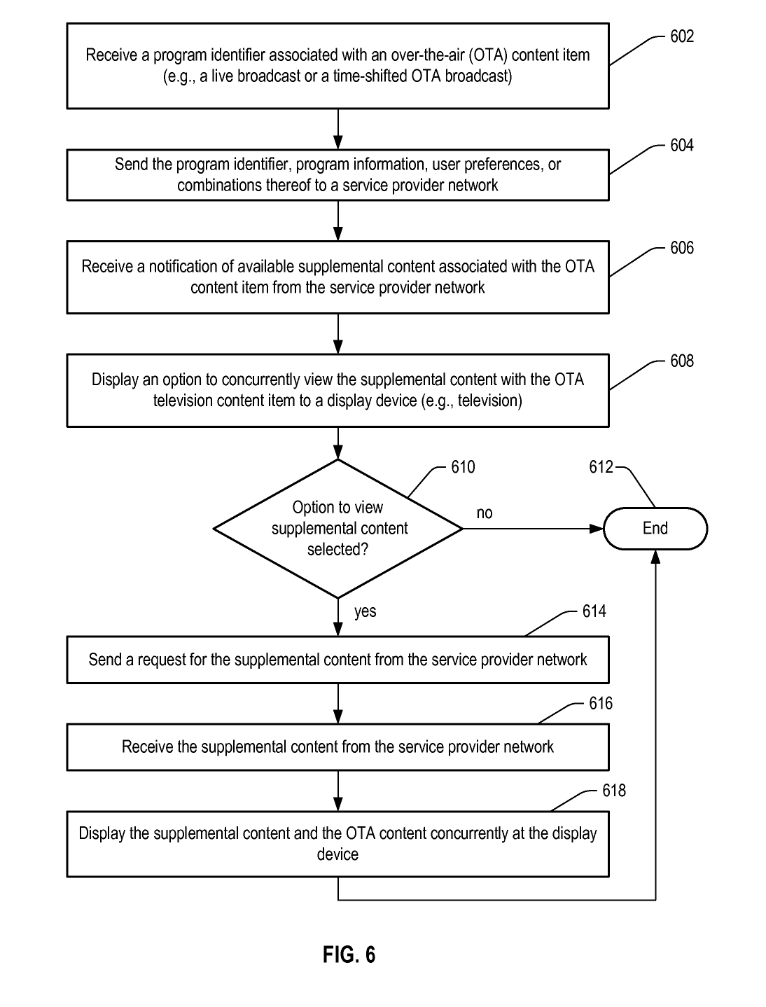

Referring to FIG. 6, a second embodiment of a method to provide data services for concurrent display with media content items is illustrated. The particular media content item may be an on-demand media content item or an OTA television content item. The particular media content item may be a live presentation or a time-delayed presentation. A live presentation occurs when the particular media content item is being retrieved from a service provider network (e.g., service provider network 104 depicted in FIG. 1) or a broadcast transmitter (e.g., a broadcast transmitter of the broadcast transmitters 110 depicted in FIG. 1) and displayed on a display device (e.g., the display device 112 depicted in FIG. 1). A time-delayed presentation occurs when the particular media content item is displayed on the display device as a playback of a recording of the particular media content item stored at a set-top box device (e.g., the set-top box device 102) or a recording device (e.g., a digital video recorder) coupled to the set-top box device. The method includes, at 602, receiving a program identifier, program information, or both, associated with the particular media content item. The program identifier, the program information, user preferences, or combinations thereof, may be sent to the service provider network, at 604.

At 606, a notification of available supplemental content associated with the particular media content item may be received from the service provider network. A GUI that includes an option to concurrently view the supplemental content with the particular media content item may be displayed on a display device (e.g., a television), at 608. The GUI may be presented for a selected period of time (e.g., for about a minute). During that time a user may use a remote control device to select the option to view the supplemental content, may use the remote control device to select an option to not view the supplemental content, or may not respond. No response may be taken to mean that the user does not wish to view the supplemental content. In some embodiments, the user may be able to redisplay the GUI by pressing an appropriate button on the remote control device.

At 610, a determination of whether a user has selected the option to view supplemental content may be made. When the user has not selected the option to concurrently view the supplemental content with the particular media content item, the method may end, at 612. When the user selects the option to concurrently view the supplemental content with the particular media content item, the method may proceed to 614, where a request for the supplemental content is sent to the service provider network.

At 616, the supplemental content may be received from the service provider network. The supplemental content and the particular media content item may be concurrently displayed on the display device, at 618. The method then ends at 612.

Embodiments disclosed herein may transform viewing of a media content item, and especially an OTA television content item, into an enhanced experience by pairing the media content item with one or more interactive data services. The paired media content item and selected interactive data services may be displayed on the same display device. For example, when the user is watching a financial program, data services such as relevant stock ticker information available via the Internet may be concurrently displayed with the financial program. When the user is watching a sporting event, data services such as supplemental score tickers, fantasy team updates, other information, or combinations thereof may be displayed concurrently with the sporting event. When the user is watching an entertainment program, data services such as presentations of listings of other programs that include actors in the entertainment program, presentation of listings of other programs directed by the same director as the entertainment program, interactive voting applications related to the entertainment program when applicable, other information, or combinations thereof, may be displayed concurrently with the entertainment program. Using the set-top box to retrieve a supplemental content listing based only on a program identifier and applicable user preferences may reduce bandwidth requirements needed to find supplemental content as compared to using a separate device (e.g., a computer system) to find supplemental content and may efficiently use limited resources of the set-top box device since a listing of supplemental content is determined and provided by a service provider network. Ready access to relevant services may result in higher service satisfaction and customer loyalty. Ready access to relevant services may provide the opportunity to sell data services that require access fees to the customers, or may allow the sale of advertisements.

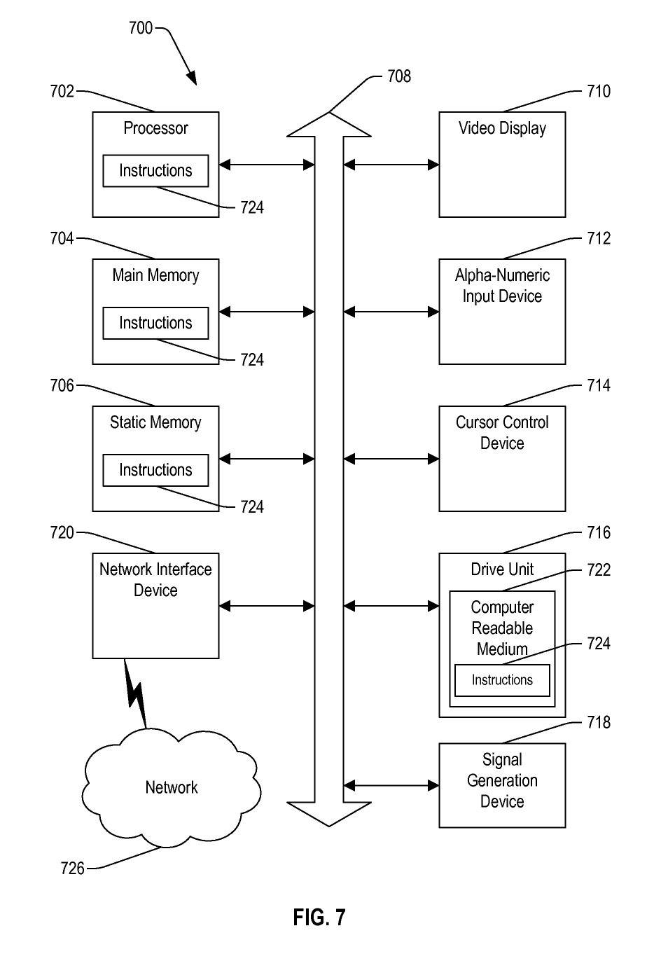

Referring to FIG. 7, an illustrative embodiment of a general computer system is shown and is designated 700. The computer system 700 may include a set of instructions that can be executed to cause the computer system 700 to perform any one or more of the methods or computer based functions disclosed herein. The computer system 700 may operate as a standalone device or may be connected, e.g., using a network, to other computer systems or peripheral devices. For example, the computer system 700 may include or be included within any one or more of the set top box device 102, the service provider network 104, the display device 112, the remote control device 114, the supplement content server 148, the intake servers 150, the routers 152, the firewalls 154, the EPG servers 156, and the authentication server 164 described with reference to FIG. 1.

In a networked deployment, the computer system 700 may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a web appliance, or any other machine capable of executing a set of instructions (sequential or otherwise) that specify actions to be taken by that machine. In a particular embodiment, the computer system 700 may be implemented using electronic devices that provide video, audio, or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 may include a main memory 704 and a static memory 706, which can communicate with each other via a bus 708. As shown, the computer system 700 may further include a video display unit 710, such as a liquid crystal display (LCD), a projection television system, a flat panel display, or a solid state display. Additionally, the computer system 700 may include an input device 712, such as a keyboard, and a cursor control device 714, such as a mouse. The computer system 700 may also include a disk drive unit 716, a signal generation device 718, such as a speaker or remote control, and a network interface device 720. Some computer systems 700 may not include an input device (e.g., a server may not include an input device).

In a particular embodiment, as depicted in FIG. 7, the disk drive unit 716 may include a computer-readable storage medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a computer-readable storage medium that stores instructions 724 or receives, stores and executes instructions 724 responsive to a propagated signal, so that a device connected to a network 726 may communicate voice, video or data over the network 726. Further, the instructions 724 may be transmitted or received over the network 726 via the network interface device 720.

While the computer-readable storage medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable storage medium may include a solid-state memory such as a memory card or other package that houses one or more non-volatile read-only memories. Further, the computer-readable storage medium may be a random access memory or other volatile re-writable memory. Additionally, the computer-readable storage medium may include a magneto-optical or optical medium, such as a disk or tapes or other storage device. A digital file attachment to an e-mail or other self-contained information archive or set of archives may be considered equivalent to a tangible storage medium. Accordingly, the disclosure is considered to include any one or more of a computer-readable storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
receiving a program identifier associated with an over-the-air (OTA) television content item from a set-top box device;
identifying one or more supplemental content items associated with the OTA television content item based on the program identifier; and
transmitting a notification to the set-top box device indicating an availability of the one or more supplemental content items.

2. The method of claim 1, further comprising:
receiving a request for the one or more supplemental content items from the set-top box device;
retrieving the one or more supplemental content items; and
transmitting the one or more supplemental content items to the set-top box device for concurrent display with the OTA television content item.

3. The method of claim 2, wherein the one or more supplemental content items are available via the Internet and wherein the one or more supplemental content items are transmitted to the set-top box device via the Internet.

4. The method of claim 1, wherein the one or more supplemental content items are identified based on program metadata associated with the OTA television content item, the program metadata retrieved from a metadata server based on the program identifier.

5. The method of claim 4, wherein the program metadata includes information associated with one or more of a genre, a subject, an athlete, a team, a cast member, and a crew member of the OTA television content item.

6. The method of claim 4, wherein identifying the one or more supplemental content items based on the program metadata includes performing one of an Internet keyword search of the program metadata and a database query based on the program metadata.

7. The method of claim 4, wherein identifying the one or more supplemental content items based on the program metadata includes performing a keyword search of the program metadata at a supplemental content server.

8. The method of claim 1, further comprising receiving program information associated with the OTA television content item from the set-top box device, wherein the program information is extracted from a broadcast stream of the OTA television content item and wherein the one or more supplemental content items are identified based at least in part on the program information.

9. The method of claim 8, wherein the program information includes program information and system information protocol (PSIP) metadata.

10. The method of claim 8, wherein the program information includes digital television (DTV) datacast data, motion picture experts group 2 (MPEG-2) flag data, or any combination thereof.

11. The method of claim 1, wherein the one or more supplemental content items include one or more of data from an interactive data service and an interactive application.

12. The method of claim 1, further comprising receiving one or more user preferences from the set-top box device, wherein the one or more supplemental content items are further identified based on the one or more user preferences.

13. A computer-readable storage medium comprising instructions, that when executed by a processor, cause the processor to:
receive a program identifier associated with an over-the-air (OTA) television content item;
send the program identifier to a server;
receive a notification of available supplemental content associated with the OTA television content item from the server; and
display an option to concurrently view the supplemental content concurrently with the OTA television content item at a display device.

14. The computer readable storage medium of claim 13, further comprising instructions, that when executed by the processor, cause the processor to:
receive a selection of the option;
send a request for the supplemental content to the server;
receive the supplemental content from the server; and
display the supplemental content and the OTA television content item concurrently at the display device.

15. The computer readable storage medium of claim 13, wherein the OTA television content item comprises a live broadcast.

16. The computer readable storage medium of claim 13, wherein the OTA television content item comprises a time-shifted broadcast.

17. The computer readable storage medium of claim 16, wherein the time-shifted broadcast comprises playback of a previously recorded OTA television content item.

18. A system, comprising:
a network interface configured to:
receive a program identifier from a device, wherein the program identifier is associated with an over-the-air (OTA) television content item; and
transmit a notification to the device indicating an availability of one or more supplemental content items associated with the OTA television content item; and
supplemental content identification logic configured to identify the one or more supplemental content items based on the program identifier.

19. The system of claim 18, wherein the network interface is further configured to:
receive a request for the one or more supplemental content items from the device;
retrieve the one or more supplemental content items; and
transmit the one or more supplemental content items to the device for concurrent display with the OTA TV program.

20. The system of claim 19, further comprising a supplemental content server, wherein the one or more supplemental content items are retrieved from the supplemental content server.
